(19) United States
(12) Patent Application Publication
(10) Pub. No.: US 2021/0114851 A1
(43) Pub. Date: Apr. 22, 2021

(54) AIRCRAFT JACK AND SYSTEM

(71) Applicants: Ken Lock, Newton Square, PA (US); Axel Schickling, Newton Square, PA (US)

(72) Inventors: Ken Lock, Newton Square, PA (US); Axel Schickling, Newton Square, PA (US)

(21) Appl. No.: 17/073,900

(22) Filed: Oct. 19, 2020

Related U.S. Application Data
(60) Provisional application No. 62/924,575, filed on Oct. 22, 2019.

(51) Int. Cl. B66F 5/02

(52) U.S. Cl. CPC B66F 5/025

(57) ABSTRACT

An aircraft jack and system is provided. The present aircraft jack may use electric, as opposed to hydraulic power. A scale may be incorporated into the jack to determine the lift load of the aircraft jack and a leveling device may be used to properly level the aircraft when lifted. A system of multiple jacks may allow the multiple aircraft jacks to communicate with each other and to synchronize movement electronically and automatically. A worm gear may also reduce the occurrence of collapse.

### REFERENCE TO RELATED APPLICATIONS

This application claims priority to U.S. Provisional Application No. 62/924,575 titled “AIRCRAFT JACK AND SYSTEM” which was filed on Oct. 22, 2019, the entire contents of which are incorporated by reference herein.

### BACKGROUND OF THE INVENTION

An aircraft jack and system is provided. The present aircraft jack may use electric, as opposed to hydraulic power. A scale may be incorporated into the jack to determine the lift load of the aircraft jack and a leveling device may be used to properly level the aircraft when lifted. A system of multiple jacks may allow the multiple aircraft jacks to communicate with each other and to synchronize movement electronically and automatically. A worm gear may also reduce the occurrence of collapse.

Jacks for aircraft are known. For example, U.S. Pat. No. 9,114,964 to Spinazze discloses a two-stage jack apparatus for lifting aircraft having: a tripod base having three legs; a base tube; a ring having an orifice there through, wherein the ring engaging end of each leg is attached to the ring; a cylinder housing a jack wherein the base tube supports the cylinder and wherein the cylinder extends through the orifice of the ring; a two stage hydraulic extension attached to the jack; and a dual speed hand pump comprising a high volume low pressure pump for quick ram actuation to the jack point and a low volume high pressure pump used to actuate rams with a hydraulic pump.

Further, U.S. Pat. No. 7,942,383 to Tharp discloses a jack for lifting the nose gear on a lightweight aircraft having a wheeled tray adapted to hold weights, a handle for manually moving the jack, and a winch mounted on the jack. The winch including a line adapted to attach to a tie down point on a tail section of the aircraft. Also, a method of using the jack to service the nose gear of alight aircraft including the steps of, loading a weight on a tray, wheeling the tray under a tail section of the aircraft, attaching a line to a tie down point on the airplane opposite the nose gear, and winching the line to apply a downward force on a tail section of the aircraft to lift the nose gear of the airplane off the ground.

Still further, U.S. Pat. No. 6,409,151 to Cormier discloses a mechanical jack for lifting an object having a lever, a base and a fulcrum disposed between the lever and the base and a post for supporting the object being lifted with the post pivotally attached to the lever and a rod movably disposed between the post and the lever and the post cooperating with the lever, the base and the fulcrum is disclosed. The mechanical jack lifts and supports a wide variety of objects including, but not limited to, a snow plow blade, a sofa, a desk, a small building, a boat, a snowmobile, an aircraft, a filing cabinet, a stove, a table and other such loads. An additional feature of the mechanical jack includes a cup member disposed near a second end of the lever which faciliates lifting objects which are inconvenient or difficult to lift. Another feature of the mechanical jack includes a clasp disposed near the first end of the lever for use for assisting in the attachment of an object such as a snow plow blade to a “V” plate mounted on a vehicle. Although the mechanical jack can operate without the need for height adjustment; however, preferably, to make the mechanical jack even more functional, a vertical height of the fulcrum and of the post may be independently adjusted.

However, these patents fail to describe an aircraft jack and system which is easy to use and efficient. Further, these patents fail to provide for an aircraft jack and system which allow multiple jacks to be automatically synchronized for proper lifting of an aircraft.

### SUMMARY OF THE INVENTION

An aircraft jack and system is provided. The present aircraft jack may use electric, as opposed to hydraulic power. A scale may be incorporated into the jack to determine the lift load of the aircraft jack and a leveling device may be used to properly level the aircraft when lifted. A system of multiple jacks may allow the multiple aircraft jacks to communicate with each other and to synchronize movement electronically and automatically. A worm gear may also reduce the occurrence of collapse.

An advantage of the present aircraft jack and system is that the present aircraft jack and system may use electric power as opposed to hydraulic power.

Still another advantage of the present aircraft jack and system is that the present aircraft jack and system may incorporate a scale to determine the supported weight of the aircraft when lifted.

And yet another advantage of the present aircraft jack and system is that the present aircraft jack and system may use a level to properly raise an aircraft.

And still another advantage of the present aircraft jack and system is that the present aircraft jack and system may allow multiple jacks to communicate with each other to synchronize movement of the aircraft upward or downward.

Finally, an advantage of the present aircraft jack and system is that the present aircraft jack and system may use a worm gear to reduce the chances of collapse of the jack.

For a more complete understanding of the above listed features and advantages of the present aircraft jack and system reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a front view of one of the aircraft jacks in the present system.

FIG. 2 illustrates a perspective view of one of the aircraft jacks in the present system wherein the support rod is in the upward, raised position.

FIG. 3 illustrates an image of the present aircraft jack supporting a portion of an aircraft.

FIG. 4 illustrates a perspective view of the aircraft jack in an embodiment.

FIG. 5 illustrates multiple aircraft jacks of the present system being used in a synchronized manner on the same aircraft.

FIG. 6 illustrates a side view of a leg of the aircraft jack of the present application.

FIG. 7 illustrates a top view of the leg of an aircraft jack of the present application.

### DETAILED DESCRIPTION OF THE PREFERRED EMBODIMENTS

An aircraft jack and system is provided. The present aircraft jack may use electric, as opposed to hydraulic power. A scale may be incorporated into the jack to determine the lift load of the aircraft jack and a leveling device may be used to properly level the aircraft when lifted. A system of multiple jacks may allow the multiple aircraft jacks to communicate with each other and to synchronize movement electronically and automatically. A worm gear may also reduce the occurrence of collapse.

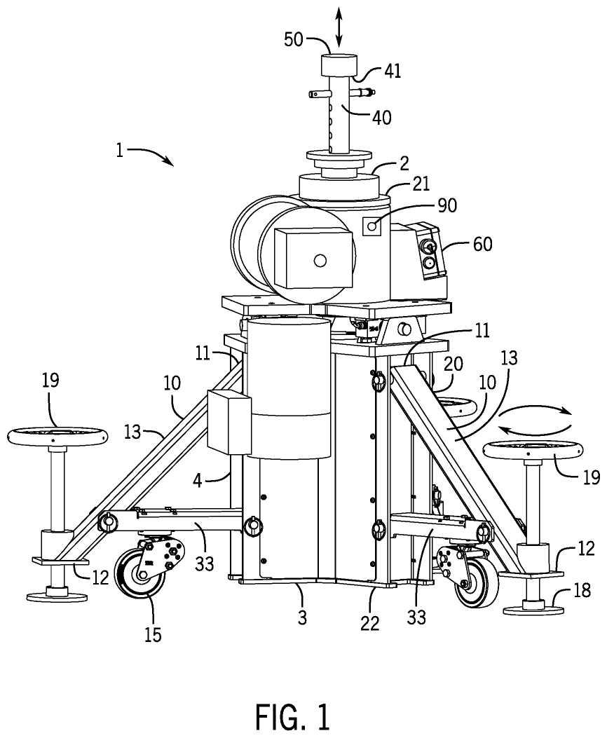

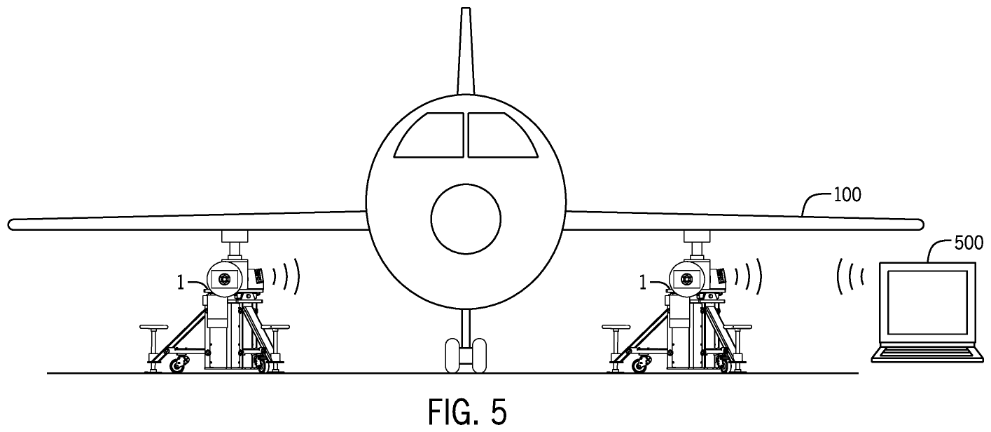

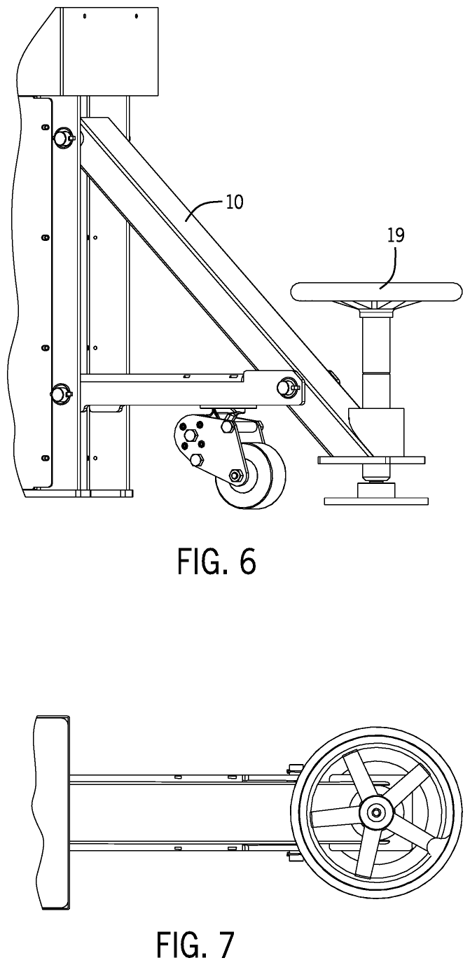

Referring first to FIG. 1, in an embodiment, an aircraft jack 1 is provided. The aircraft jack 1 may have a top 2, a bottom 3 and a side 4. In an embodiment, the side 4 may be generally cylindrical, triangle-shaped or may be of other suitable shapes. The aircraft jack 1 may support an aircraft 100 (FIG. 5) or portion thereof, so that work may be conducted on the aircraft 100. Further, a plurality of the present aircraft jacks 1 may be used together in a system (FIG. 5) with synchronized movement to more accurately control the lifting/movement of the aircraft 100.

The aircraft jack 1 may have multiple legs 10. The legs 10 of the aircraft jack 1 are generally modular, and therefore can be more easily disassembled and transported compared to welded legs on other aircraft jacks. Further, the modular nature of the legs allows replacement of parts of the jack much more easily then replacing a welded portion of the leg of a standard aircraft jack. Further, the modular nature of the legs 10 allows for expansion/adjustment of the legs depending on the aircraft 100 for which the jack 1 is being used upon.

Although the images show the present aircraft jack 1 has having three legs 10, it should be noted that the present aircraft jack 1 may use more than three legs 10 in an embodiment. In an embodiment, each leg 10 of the aircraft jack 1 may have a top end 11, a bottom end 12 and a side portion 13. A wheel 15 (or spring ball roller in an embodiment) may be located at or near the bottom end 12 of at least one of the legs 10. The wheel 15 may allow the aircraft jack 1 to be rolled into place without the need to lift the aircraft jack 1 while transporting the jack 1. A locking mechanism (not shown) may lock the wheels 15 in place once the present aircraft jack 1 is properly positioned under the aircraft 100 or when the aircraft jack 1 is not used and is in storage.

Alternatively, or in addition to the wheels 15, the bottom end 12 of each of the plurality of legs 10 may have a flat support plate 18 (FIG. 1) which may contact the ground. In an embodiment, a threaded member (not visible) attached to the support plate 18 may be connected and pass through the leg 10 to a rotating adjustment wheel 19. The adjustment wheel 19 may allow a user to adjust the height of each leg 10 independently so as to level the jack 1 manually in one method of use. Preferably, the adjustment wheel 19 is located above the leg 10 and in a perpendicular manner with respect to the leg 10 so that the leg 10 is at the center of the adjustment wheel 19 so that the wheel 19 may be efficiently controlled.

The present aircraft jack 1 may have a central housing unit 20. The central housing unit 20 may be located between the legs 10 and may have a top end 21 and a bottom end 22. Each of the plurality of legs 10 of the present aircraft jack 1 may be secured to the central housing unit 20. In particular, the top end 11 of each of the legs 10 may be secured to the central housing unit 20. A brace 33 may connect the legs 10 (near the bottom of the legs) to the central housing unit 20 to extend the legs 10 outward for support. In an embodiment, the braces 33 may be adjustable lengthwise by telescoping units. Further, in an embodiment the wheel 15 may actually be secured to the braces 33 of the legs 10 in one embodiment (as is depicted in the drawings).

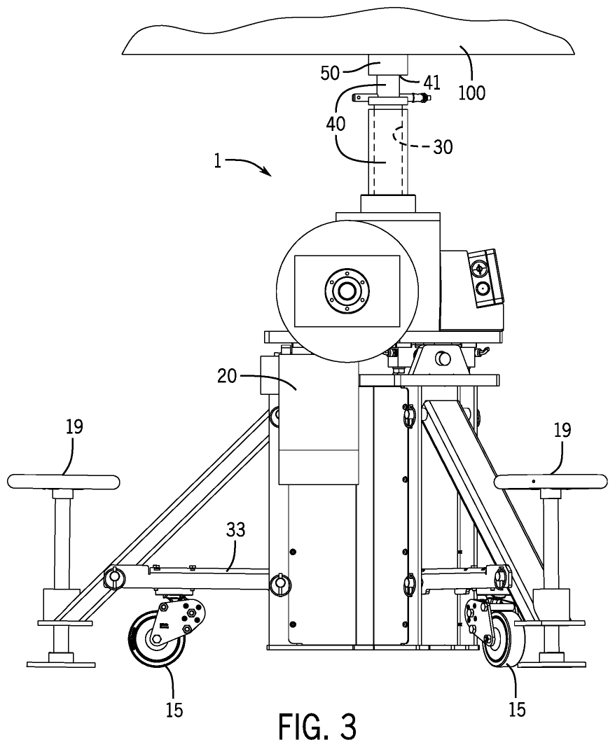

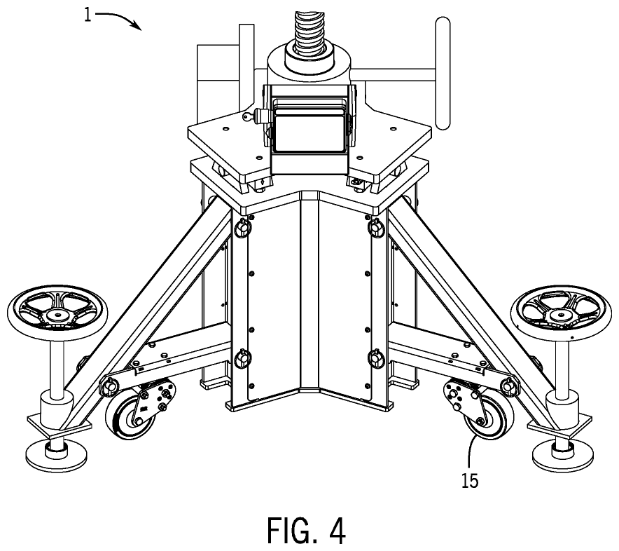

The central housing unit 20 may have a hollow interior channel 30 (FIG. 3). The hollow interior channel 30 may receive a support rod 40 having a top end 41 and a bottom end (not visible) wherein the bottom end remains permanently located within the central housing unit 20 during use while the top end 41 may be raised or lowered. The support rod 40 may move vertically with respect to the stationary central housing unit 20. Located on the top end 41 of the support rod 40 may be, in an embodiment, a support pad 50 which may directly contact the aircraft 100 when lifting of the aircraft 100 is performed by the present aircraft jack 1.

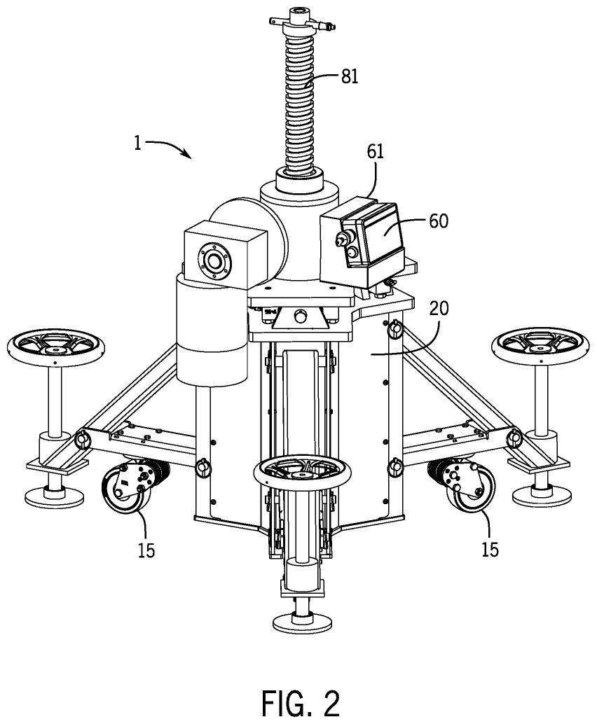

In an embodiment, the present aircraft jack 1 may have a worm gear system 81 (FIG. 2) which may help reduce the chances of the damage to the aircraft 100 in the event of the aircraft jack 1 failing. More specifically, in one embodiment, the support rod 40 may incorporate a worm gear 81 wherein the support rod 40 rotates along the worm gear 81 when the support rod 40 is either raised or lowered. As a result, if the aircraft jack 1 fails, the worm gear 81 may reduce the chances of the support rod 40 rapidly collapsing into the central housing unit 20 as a result of the threading of the worm gear 81 helping to support the weight of the aircraft 100.

In an embodiment, the aircraft jack 1 may be powered by electrical power, as opposed to hydraulic power which typically powers other standard aircraft jacks. In particular, an internal battery or an electrical cord may be connected to the central housing unit 20 and may power the support rod 40, moving it upward and/or downward.

In an embodiment, the aircraft jack 1 may have a built-in scale 60 (FIG. 2). The scale 60 may electrically record, display and electrically communicate the supported weight placed on the support pad 50 during use. The recorded weight may also be communicated to a central computer 500 (FIG. 5) and may also be wirelessly communicated to the other (generally identical) aircraft jacks 1 which are part of a system of jacks used on a particular aircraft as shown in FIG. 5. In one embodiment, the jacks 1 of the systems may transmit wireless signals via Bluetooth and/or lasers.

In an embodiment, the present aircraft jack 1 may have an automatic, computer leveling device 61 which may, in an embodiment, also record, display and communicate information to the central computer 500 and/or to the other aircraft jacks 1 of the system. The leveling device 61 may automatically slightly raise or lower the support pad 50 so that, for example, the wings of the aircraft 100 remain level; or, alternatively, the aircraft jack system may be programed to raise the aircraft 100 in a non-level manner if desired.

In an embodiment, the present aircraft jack 1 therefore has both a manual adjustment level (the wheel 19) and an automatic leveling device 61 to level the aircraft 100. Accordingly, the two leveling devices may allow for more precise leveling of the aircraft 100 as well as the two systems may provide a back-up in the event one of the leveling systems fails.

Finally, each of the plurality of aircraft jacks 1 may have a laser generating device 90 (FIG. 1). The laser generator 90 may produce a laser beam which is received by at least one of the other aircraft jacks 1 of the system. The received laser beam is processed by the receiving aircraft jack 1 and data is collected from the laser including the precise height of the sending aircraft jack's support rod 40 and the speed of movement of the support rod 40 so that multiple aircraft jacks 1 of the present system may work together to raise or lower the aircraft 100 in a level and synchronized manner.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

We claim:

1. An aircraft jack comprising:
a central housing unit having a side and a hollow interior channel;
a plurality of legs secured to the central housing unit;
a support rod having a first end and a second end wherein the support rod telescopingly moves from a first position to a second position within the hollow interior channel of the central housing unit; and
wherein the support rod is capable of raising or lowering a portion of an aircraft and wherein the movement of the support rod with respect to the central housing unit is accomplished by electrical power.

2. The aircraft jack of claim 1 further comprising:
a wheel secured to a bottom of each of the plurality of legs.

3. The aircraft jack of claim 2 further comprising:
a brake locking mechanism connected to each wheel wherein the brake locking mechanism locks a wheel into place.

4. The aircraft jack of claim 1 further comprising:
a worm gear associated with the support rod wherein the movement of the support rod from the first position to the second position within the hollow channel of the central housing unit is done by a worm gear.

5. The aircraft jack of claim 1 further comprising:
a rotating adjustment wheel located above each of the plurality of legs wherein the rotating adjustment wheel raises or lowers the leg with respect to the central housing unit.

6. The aircraft jack of claim 1 further comprising:
a support pad for lifting an object attached to the support rod.

7. The aircraft jack of claim 1 further comprising:
an automatic leveling device to level the aircraft jack.

8. The aircraft jack of claim 1 further comprising:
a scale attached to the main housing unit.

9. An aircraft jack system comprising:
a plurality of aircraft jacks each of the aircraft jacks having:
i) a central housing unit having a side and a hollow interior channel;
ii) a plurality of legs secured to the central housing unit;
iii) a support rod having a first end and a second end wherein the support rod telescopingly moves from a first position to a second position within the hollow interior channel of the central housing unit; and
iv) wherein the support rod is capable of raising or lowering a portion of an aircraft and wherein the movement of the support rod with respect to the central housing unit is accomplished by electrical power; and
wherein each of the plurality of aircraft jacks is in communication with each other and wherein the movement of the support rods of the plurality of aircraft jacks is electrically synchronized among the aircraft jacks.

10. The aircraft jack system of claim 9 further comprising:
a leveling device on each of the plurality of aircraft jacks.

11. The aircraft jack system of claim 9 further comprising:
a laser on each of the plurality of aircraft jacks wherein the laser of one aircraft jack is directed to another aircraft jack of the system and wherein the receipt of the laser from one aircraft jack provides information to the receiving aircraft jack and allows the plurality of aircraft jacks to work in a synchronized manner.

12. The aircraft jack system of claim 9 further comprising:
a wheel secured to a bottom of each of the plurality of legs.

13. The aircraft jack system of claim 12 further comprising:
a brake locking mechanism connected to each wheel wherein the brake locking mechanism locks a wheel into place.

14. The aircraft jack system of claim 9 further comprising:
a worm gear associated with the support rod of each of the plurality of jacks wherein the movement of the support rod from the first position to the second position within the hollow channel of the central housing unit is done by a worm gear.

15. The aircraft jack system of claim 9 further comprising:
a rotating adjustment wheel located above each of the plurality of legs of each of the aircraft jacks wherein the rotating adjustment wheel raises or lowers the plurality of legs with respect to the central housing unit.

16. The aircraft jack system of claim 9 further comprising:
a support pad for lifting an object attached to the support rod of each of the plurality of aircraft jacks.
